(19) United States
(12) Patent Application Publication
(10) Pub. No.: US 2025/0328353 A1
(43) Pub. Date: Oct. 23, 2025

(54) DEVICE ONBOARDING IN DISTRIBUTED SYSTEMS USING ATTESTED PAYLOADS

(71) Applicant: Dell Products L.P., Round Rock, TX (US)

(72) Inventors: BRADLEY K. GOODMAN, Nashua, NH (US); JOSEPH CAISSE, Burlington, MA (US); JAMES DANIEL HARMS, Worthington, OH (US); JOHN JIAN LI, Westford, MA (US)

(21) Appl. No.: 18/643,262

(22) Filed: Apr. 23, 2024

(51) Int. Cl. G06F 9/4401; G06F 9/455; G06F 21/44

(52) U.S. Cl. CPC G06F 9/4406; G06F 9/45541; G06F 21/44

(57) ABSTRACT

Methods and systems for managing endpoint devices are disclosed. The endpoint devices may be managed by onboarding them. To onboard the endpoint devices, an orchestrator may provide a payload to a rendezvous system. The rendezvous system, instead of redirecting an endpoint device to the orchestrator, may then directly provide this payload (after the rendezvous device has first attested an integrity of this payload) to the endpoint device. Upon receiving the attested payload from the rendezvous system, the endpoint device may use the attested payload to complete certain processes such as bare metal orchestration (BMO) without needing to onboard itself onto a control plane on which the orchestrator is sitting.

### FIELD

Embodiments disclosed herein relate generally to device management. More particularly, embodiments disclosed herein relate to systems and methods to manage onboarding of devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIGS. 1B-1K show diagrams illustrating aspects of operation of the system of FIG. 1A in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing authority in a distributed system. To manage authority, endpoint devices may be onboarded.

During onboarding, authority over the endpoint devices may be established. To establish the authority, ownership vouchers, and/or other data structures may be presented to the endpoint devices. The endpoint devices may utilize these data structures to identify the entities that have authority over the endpoint devices.

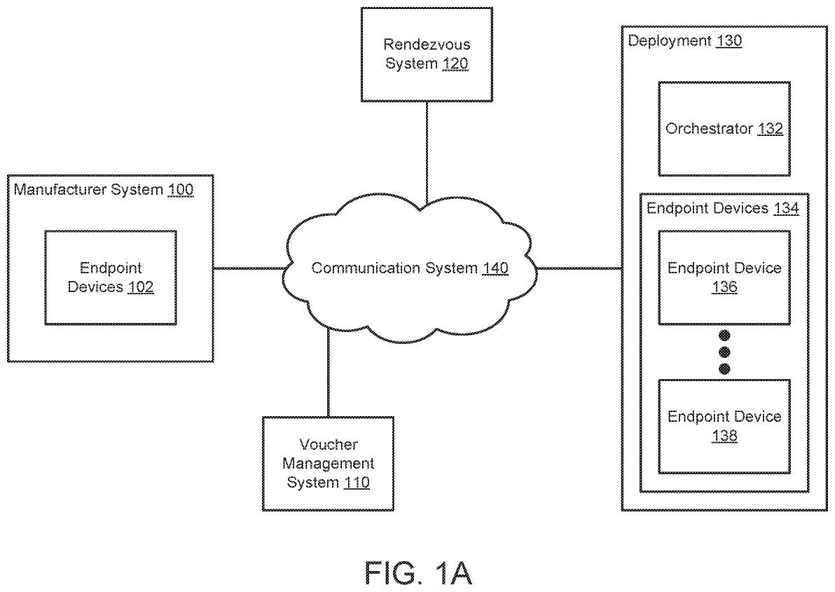

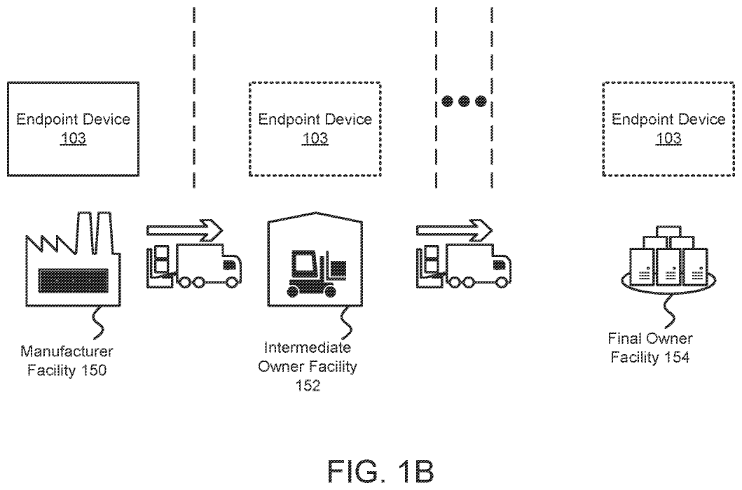

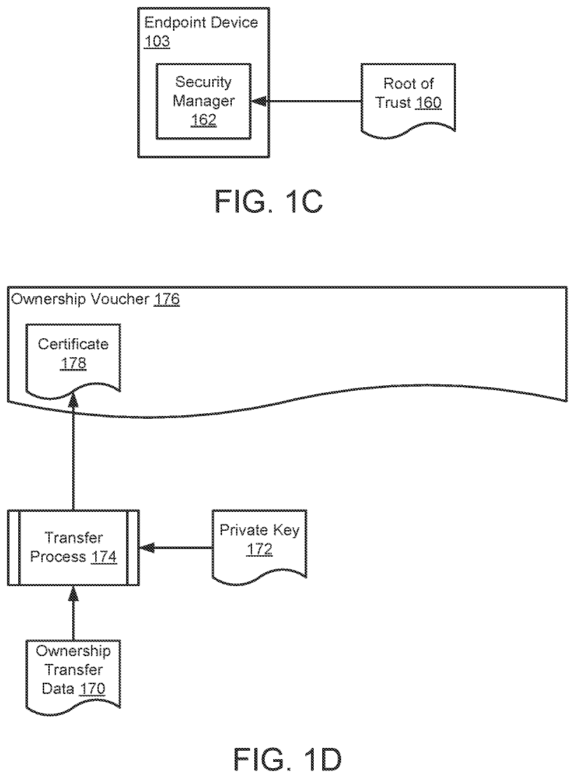

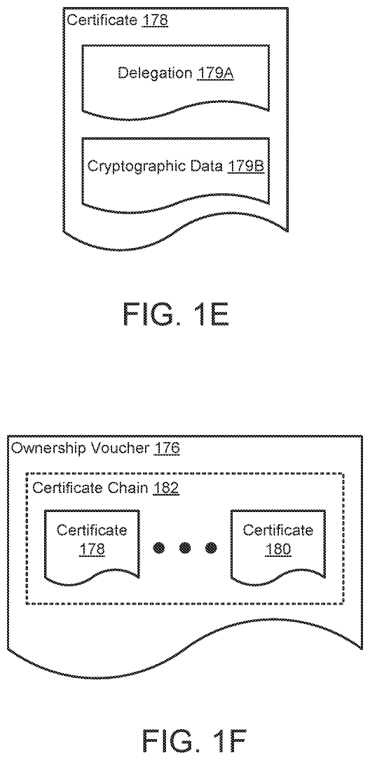

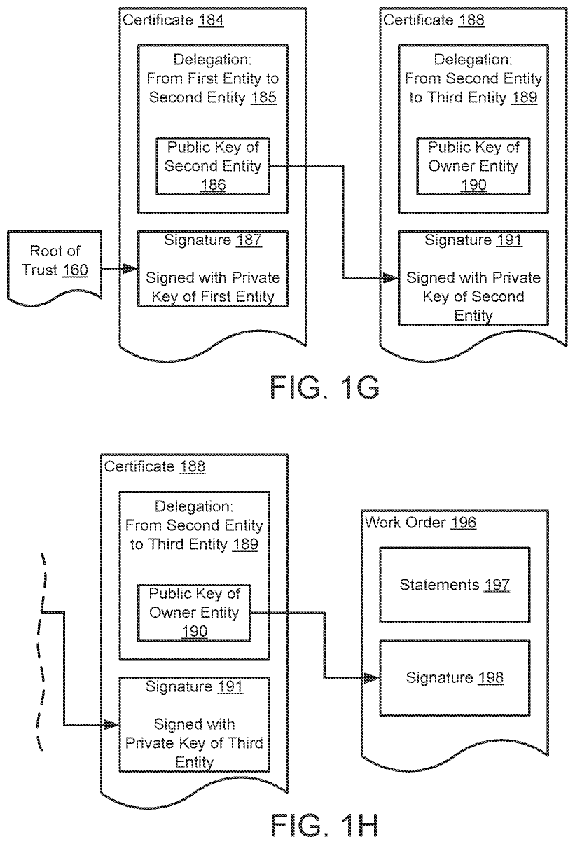

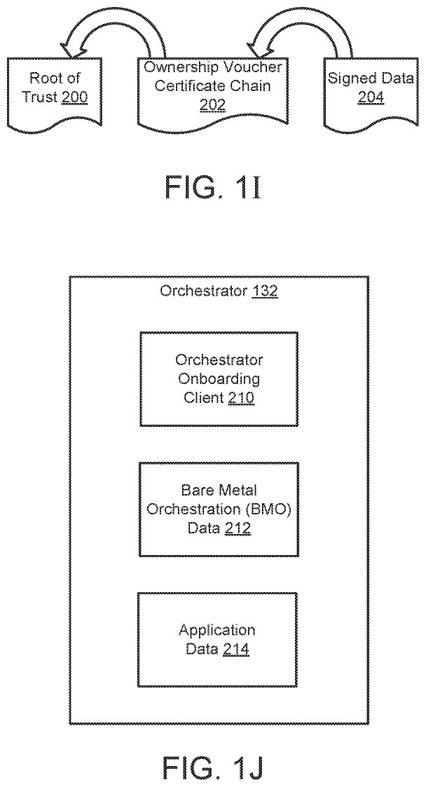

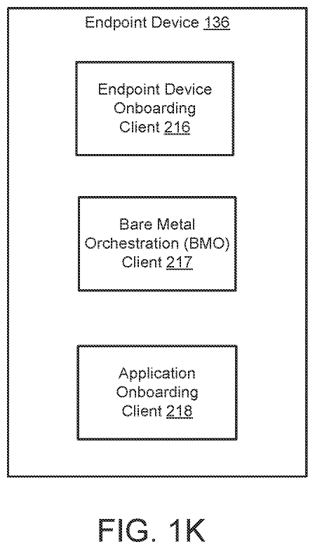

These ownership vouchers may also be useful for improving onboarding of an endpoint device onto the endpoint device's intended control plane (see below discussion regarding deployment 130 and orchestrator 132 in reference to FIG. 1A). In particular, by allowing a device (e.g., computing devices) to cryptographically verify another device's authority over an endpoint device, ownership vouchers may be provided to any device (e.g., rendezvous system, orchestrator, or the like) involved in an endpoint device's onboarding to the intended control plane.

More specifically, in embodiments, a rendezvous system may be provided with an endpoint device's ownership voucher to: (i) redirect the endpoint device to a specific orchestrator that has proven to the rendezvous system that it has authority over the endpoint device; (ii) verify data provided by the orchestrator that is intended to be forwarded to the endpoint device; and much more.

In an example of case (ii), an orchestrator may provide bare metal orchestration (BMO) instructions intended for an endpoint device to the rendezvous system. As such, instead to be redirected to the orchestrator by the rendezvous system, the endpoint device would be able to directly receive such BMO instructions from the rendezvous system and complete BMO before having to re-onboard to the orchestrator to complete application onboarding (e.g., completing implementation of application configurations and settings after the applications are installed during BMO).

Because the rendezvous system will have access to the endpoint device's ownership voucher, the rendezvous system will be able to attest to an integrity (and safety) of the BMO instructions (and/or other data received in the form of a payload) received from the orchestrator. Such attested data (referred to herein as “attested payload”) can then be provided to the endpoint device when the endpoint device sends an onboarding request to the rendezvous system.

By eliminating the need to onboard twice onto one or more control planes (e.g., once for BMO and once for application onboarding), an improved system may be obtained where limited computing resources of the endpoint device (that were previously used for the initial onboarding to complete BMO) can be used for other needed processes (e.g., security, faster boot up, or the like).

Accordingly, embodiments disclosed herein may address, among others, inefficiencies (and technical problems associated with such inefficiencies) during onboarding of endpoint devices in a distributed system. The disclosed embodiments may do so by providing the rendezvous system with certain data (e.g., BMO instructions, application configurations, or the like) that could help eliminate one or more steps (e.g., processes) that were used in convention onboarding methods.

In an embodiment, a method for managing an endpoint device of endpoint devices in a deployment is provided. The method may include: during an onboarding of the endpoint device and by the endpoint device: obtaining bare metal orchestration (BMO) instructions; using the BMO instructions to complete a BMO of the endpoint device; and after completing the BMO of the endpoint device, completing the onboarding of the endpoint device to a control plane in cooperation with an orchestrator, the orchestrator being located within the control plane to which the endpoint device is to connect and receive onboarding data for completing the onboarding.

The BMO instructions are obtained from a rendezvous system that is disposed external to the control plane from which the endpoint device is to be provided with the onboarding data.

The method may further include: before obtaining the BMO instructions from the rendezvous system: transmitting a request to the rendezvous system, the request being for obtaining information regarding an entity to contact for obtaining the BMO instructions, the entity being the orchestrator; and receiving, in response to the request and directly from the rendezvous system without the endpoint device having to first contact the entity, the BMO instructions in addition to the information as part of the BMO instructions.

The BMO instructions are signed using a secret key associated with a current owner of the endpoint device.

The BMO instructions are provided to the rendezvous system by the orchestrator prior to the endpoint device transmitting a request to the rendezvous system to initiate an onboarding process, and the rendezvous system validates an integrity of the BMO instructions by validating that the orchestrator is associated with the current owner of the endpoint device.

The method may further include: before using the BMO instructions to complete the BMO of the endpoint device: validating an integrity of the BMO instructions using an ownership voucher of the endpoint device; and determining that the BMO instructions are trusted using the ownership voucher.

The ownership voucher comprises another key associated with the current owner of the endpoint device, the another key being a public key of a public private key pair, and the secret key being a private key of the public private key pair, and determining that the BMO instructions are trusted comprises determining that the another key is referenced by the secret key used to sign the BMO instructions.

The orchestrator is both a BMO control plane and an application control plane of the endpoint device.

The endpoint device comprises a BMO client and an application onboarding client that is different from the BMO client, the BMO client being used to complete the BMO of the endpoint device.

Completing the onboarding of the endpoint device with the orchestrator after completing the BMO of the endpoint device may include: executing, by the application onboarding client, application onboarding data to complete configuration of one or more applications installed on the endpoint device after completing the BMO of the endpoint device.

In an embodiment, a non-transitory media is provided. The non-transitory media may include instructions that when executed by a processor cause the computer-implemented method to be performed.

In an embodiment, a data processing system (e.g., an endpoint device) is provided. The data processing system may include the non-transitory media and a processor, and may perform the method when the computer instructions are executed by the processor.

Turning to FIG. 1A, a block diagram illustrating a system in accordance with an embodiment is shown. The system shown in FIG. 1A may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, any number of endpoint devices may be deployed to a deployment. The endpoint devices may cooperatively provide the computer implemented services.

To manage the endpoint devices to provide the computer implemented services, authority over the endpoint devices may need to be established. In other words, the endpoint devices must be able to ascertain that they are under the authority of a particular entity. Based on this authority, the entity may, for example, issue work order and/or other types of instructions to manage the operation of the endpoint devices to provide desired computer implemented services.

To facilitate ascertaining of the authority over them, the endpoint devices may utilize secrets. The secrets may allow the endpoint devices to cryptographically verify delegations of authority over the endpoint devices from a root of trust (e.g., a trusted key of a manufacturer) to another entity (e.g., an owner).

Overtime the resources requirements for providing computer implemented services may change and/or endpoint devices may need to be replaced. For example, additional services may be desired to be provided, different types of services may be desired to be provided, etc. In another example, an endpoint device that contributed to the computer implemented services may cease to operate thereby reducing the quantity of resources available to provide the computer implemented services. To satisfy the resource requirements based on these changes to an exist systems, additional endpoint devices may be onboarded and thereby contribute to the resources available to provide the computer implemented services.

However, onboarding an endpoint device may require several steps (including a first onboarding to a first control plane for BMO instructions and a second onboarding to a second control plane (or the same first control plane) for applications setting and confirmation data) that could make the onboarding process less efficient and require more use of limited computing resources (that could otherwise be used to complete the onboarding more quickly). In general, embodiments disclosed herein may provide methods, systems, and/or devices for managing an improved onboarding process of the endpoint devices.

To improve the onboarding process and eliminate certain onboarding steps that may lengthen the onboarding process and cause inefficient use of the endpoint device's limited computing resources, an orchestrator may provide a payload (e.g., a packet of data, or the like) to a rendezvous system. The rendezvous system, instead of redirecting an endpoint device to the orchestrator, may then directly provide this payload (after the rendezvous device has first attested an integrity of this payload) to the endpoint device.

Upon receiving the attested payload from the rendezvous system, the endpoint device may use the attested payload to complete certain processes (e.g., BMO) without needing to onboard itself onto a control plane on which the orchestrator is sitting. If the endpoint device only needs to complete BMO without further need of onboarding onto an application control plane (e.g., to configure the applications installed during BMO), then communication with the orchestrator may even be completely eliminated, improving not only the efficiency of the onboarding process but also reducing security risks for the endpoint devices by eliminating the number of devices the endpoint device will have to communicate with and validate to complete the onboarding of the endpoint device.

For example, if the endpoint device is a personal laptop belonging to an average consumer that does not need further control plane onboarding after an operating system has been installed on the laptop, the endpoint device would not even need to know of the existence of any control planes to complete the installation of the operating system and be ready to use by the consumer.

To provide the above noted functionality, the system of FIG. 1A may include manufacturer system 100, voucher management system 110, rendezvous system 120, deployment 130, and communication system 140. Each of these components is discussed below.

Manufacturer system 100 may be a system used by a manufacturer of endpoint devices 102. Manufacturer system 100 may include, for example, factories, assembly plants, distribution facilities, and/or other types of facilities for creating endpoint devices 102. Endpoint devices 102 may be data processing systems which may be usable to provide various computer implemented services.

When manufactured, manufacturer system 100 may put endpoint devices 102 in condition for subsequent onboarding to various deployments (e.g., 130) and/or other environments (e.g., data centers, edge systems, etc.) in which endpoint devices may be positioned to provide desired computer implemented services.

To place endpoint devices 102 in condition for subsequent onboarding, manufacturer system 100 may (i) establish a root of trust for each endpoint device, (ii) record various information regarding the endpoint devices (e.g., hardware/software loadout, identifiers of various components positioned therein, etc.), and (iii) install various pieces of software, establish various configuration settings, update various hardware components, and/or perform other actions so that only entities to which authority over the endpoint devices has been delegated from the root of trust are able to control and/or otherwise use the endpoint device. Refer to FIG. 1C for additional details regarding establishing a root of trust for the endpoint device.

Once constructed, endpoint devices 102 may be sold directly to end users and/or placed into the stream of commerce (e.g., sold to resellers, etc.) and through which endpoint devices 102 eventually reach end users. Refer to FIG. 1B for additional details regarding how endpoint devices may reach end users (e.g., individuals, organizations, etc.).

As ownership over the endpoint devices changes, information regarding the changes in ownership and/or authority may be recorded in an ownership voucher. The ownership voucher may allow an end user to establish authority over the endpoint device such that the endpoint device will be usable by the end user.

Voucher management system 110 may document and manage information regarding changes in ownership and authority over endpoint devices 102. To do so, voucher management system 110 may generate ownership vouchers. An ownership voucher may be a cryptographically verifiable data structure usable to establish which entities have authority over endpoint devices 102.

For example, an ownership voucher may include certificate chains that documents the changes in ownership and authority over endpoint devices 102. Each certificate may be signed using various keys. The keys used to sign (e.g., private keys) and keys included in (e.g., public keys) in ownership vouchers may enable endpoint devices to ascertain whether to trust various data structures, such as work orders which may be signed. Refer to FIGS. 1D-1I for additional information regarding ownership vouchers.

When one of endpoint devices 102 is obtained by an end user, the end user may add the endpoint devices to a collection such as deployment 130. When so added, an orchestrator (e.g., 132) or other entity may utilize a corresponding ownership voucher from voucher management system 110 to establish authority over the endpoint device. In this manner, any number of endpoint devices (e.g., 134) may be onboarded and brought under the control of a control plane which may include any number of orchestrators (e.g., 132). Different endpoint devices (e.g., 136, 138) may be onboarded at different points in time and/or for different purposes.

However, the ownership voucher provided by voucher management system 110 may delegate authority over the endpoint device to the end user by establishing a public key of a public private key pair maintained by the end user (e.g., via the orchestrator 132) as having been delegated authority over the endpoint device. To issue verifiable work orders or other types of instructions to the endpoint device, the work order may need to be signed by the private key of the public private key pair.

When one of endpoint devices 102 initially powers on after manufacturing, the endpoint device may reach out to rendezvous system 120. Rendezvous system 120 may be a system that directs endpoint devices to entities such as orchestrator 132 that will onboard the endpoint devices. Rendezvous system 120 may be disposed external to a control plane (e.g., made up by orchestrator 132 (and a combination of other computing devices) of deployment 130).

To do so, the entities such as orchestrator 132 may provide rendezvous system 120 with information usable to authenticate that orchestrator 132 will manage the endpoint devices. For example, orchestrator 132 may provide information from ownership vouchers, and/or other sources to rendezvous system 120. Once verified, rendezvous system 120 may redirect endpoint devices to the corresponding entities when the endpoint devices reach out to rendezvous system 120 after being powered on.

Once onboarded, endpoint devices 134 may perform various operations to complete onboarding. The operations may include any number and type of operation (e.g., configuration operations, security operations, software installation operations, account establishment operations, etc.), and the operations may be directed by orchestrator 132. Once onboarded, the endpoint devices may begin to contribute to computer implemented services by deployment 130.

When providing their functionality, any of manufacturer system 100, endpoint devices 102, voucher management system 110, rendezvous system 120, deployment 130, orchestrator 132, and/or endpoint devices 134 may perform all, or a portion, of the processes, interactions, and methods illustrated in FIGS. 1B-3.

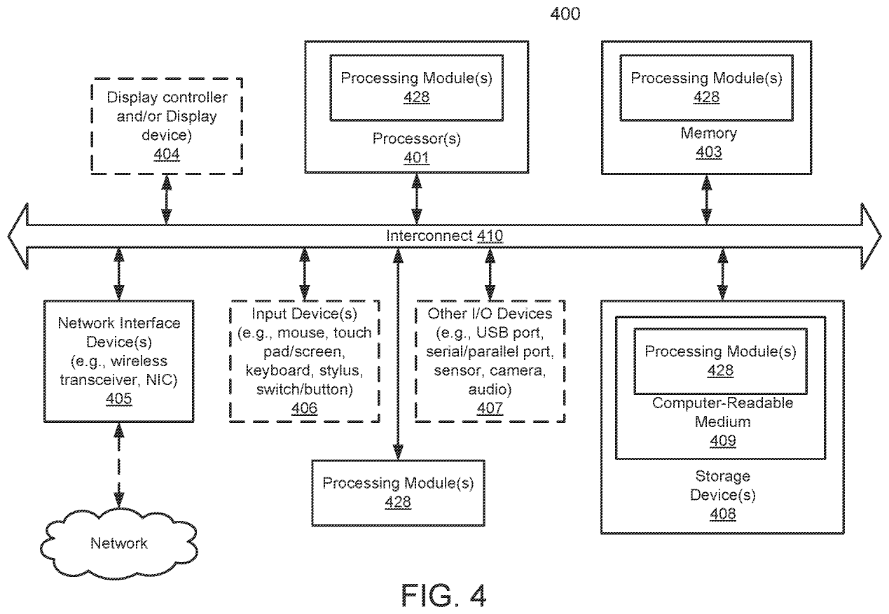

Any of manufacturer system 100, endpoint devices 102, voucher management system 110, rendezvous system 120, deployment 130, orchestrator 132, and/or endpoint devices 134 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with communication system 140. Communication system 140 may facilitate communications between the components of FIG. 1A. In an embodiment, communication system 140 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

As discussed above, endpoint devices (e.g., 102) may traverse through a stream of commerce between when the endpoint devices are manufactured and when the endpoint devices reaches a final owner. Turning to FIG. 1B, diagram of an example path through a stream of commerce in accordance with an embodiment is shown.

In FIG. 1B, vertical dashed lines indicate different geographic locations in which various facilities may be positioned. Representations of such facilities (e.g., 150-154) may be positioned below the pages. Representations of movement of endpoint devices between these facilities is illustrated using truck shaped images. Some instances of the graphical representation of endpoint device 103 are illustrated using dashed outlining to indicate that endpoint device 103 may only be present at one of the facilities at any point in time, and the instance of the graphical representation of endpoint device 103 drawn in solid outlining indicates where endpoint device 103 is located in the example shown in FIG. 1B.

The stream of commerce may begin, for example, at manufacturer facility 150. Manufacturer facility 150 may be a facility operated by a manufacturer of endpoint devices. During manufacturing, the manufacturer may establish a root of trust for an endpoint device (e.g., 103). Refer to FIG. 1C for additional details regarding establishing the root of trust for endpoint device 103. The root of trust may be used by endpoint device 103 to discern which entities have authority over it, which entities to trust, and/or for other purposes. The initial root of trust may indicate that the manufacturer is the owner of and has authority over endpoint device 103.

Once the root of trust is established, endpoint device 103 may be sold and resold to various intermediate owners. These intermediate owners may operate various intermediate owner facilities (e.g., 152), such as warehouses, distribution centers, sales rooms, etc. When sold, endpoint device 103 may be shipped to these various facilities.

Finally, once purchased from an intermediate owner, a final owner may operate a final owner facility (e.g., 154), such as a data center, edge deployment, and/or other type of computer deployment to which endpoint device 103 may be onboarded. To facilitate onboarding, voucher management system 110 may collect and add information regarding changes in ownership of endpoint device 103 to an ownership voucher. Orchestrator 132 may use the ownership voucher to establish authority over endpoint device 103.

Turning to FIG. 1C, a diagram of an example process for establishing a root of trust in endpoint device 103 in accordance with an embodiment is shown. To establish a root of trust, when endpoint device 103 is manufactured, root of trust 160 may be installed in endpoint device 103.

Root of trust 160 may be a public key of a public private key pair controlled by the manufacturer of endpoint device 103. The public private key pair may be established using any process.

To install root of trust 160, root of trust 160 may be stored in endpoint device 103. The storage location and security precautions taken with respect to storing root of trust 160 may vary depending on the architecture of endpoint device 103.

For example, endpoint device 103 may host or include a security manager (e.g., 162). Security manager 162 may be implemented using a discrete hardware component, or may be a software component. Security manager 162 may enforce various security policies on endpoint device 103. For example, the security policies may require that endpoint device 103 validate authority over it back to root of trust 160 before complying with any instructions from other entities that allege to have authority over endpoint device 103.

To validate entities having authority over endpoint device 103, endpoint device 103 may utilize ownership vouchers.

Turning to FIG. 1D, a diagram of an example process for generating ownership voucher 176 in accordance with an embodiment is shown. To generate ownership voucher 176, information regarding changes in ownership and authority over an endpoint device may be added. The information may take the form of a cryptographically verifiable certificate (e.g., 178). Refer to FIG. 1E for additional information regarding certificate 178.

To add a certificate to ownership voucher 176, transfer process 174 may be performed. During transfer process 174, ownership transfer data 170 and private key 172 may be obtained. Ownership transfer data 170 may document a change in ownership and/or authority over an endpoint device. For example, when an endpoint device is sold, a public key of a public private key pair controlled by the purchaser may be added to ownership transfer data 170, along with other types of information regarding the transfer. This public key may be usable to verify signed work orders or other signed data structures from the new owner (e.g., the new owner may be able to use the corresponding private key for signing). The information in ownership transfer data 170 may be treated as a delegation statement, which an endpoint device may parse to identify entities having authority over it.

Private key 172 may be a private key of a public private key pair controlled by an entity that has authority over an endpoint device at the time authority over the endpoint device changes (e.g., via sale or other mechanism). In a scenario in which the manufacturer is the seller, the private key corresponding to the root of trust may be private key 172. Similarly, in a scenario in which an intermediate owner is the seller, private key 172 may be the private corresponding to (e.g., referenced by) the public key included in the delegation statement in ownership voucher 176 that establishes the intermediate owner has the owner of the endpoint device. In other words, to establish a delegation of authority, the entity that has authority over the endpoint device as defined by the certificates of ownership voucher 176 may need to sign the ownership transfer data 170 to further delegate ownership and authority over the endpoint device. By doing so, a chain of delegations that are cryptographically verifiable back to the root of trust may be established. Refer to FIGS. 1F-1H for additional details regarding establishing chains of delegations.

Any number of certificates may be added to ownership voucher 176 thereby enabling certificate chains that establish chains of delegation from the root of trust for an endpoint device. Ownership voucher 176 may, as discussed above, be used during onboarding.

Turning to FIG. 1E, a diagram of an example certificate 178 in accordance with an embodiment is shown. Certificate 178 may include delegation 179A and cryptographic data 179B.

Delegation 179A may include information documenting a delegation of authority/ownership over an endpoint device. For example, delegation 179A may include a public key, and indicate what is delegated to the entity that has control over the public private key pair of which the public key is a member. The extent of what is delegated may be specified at a macro level (e.g., ownership) or a micro level (e.g., limited authority).

Cryptographic data 179B may include signature usable to verify the integrity of delegation 179A and ascertain whether delegation 179A is valid.

To determine whether certificate 178 includes a valid delegation, an endpoint device may attempt to establish a chain of delegations back to the root of trust.

Turning to FIG. 1F, a diagram of an example certificate chain 182 of ownership voucher 176 in accordance with an embodiment is shown. Certificate chain 182 may be a series of certificates that can be sequentially validated back to the root of trust. To sequentially validate the certificate back to the root of trust, the first certificate (e.g., 178) in the chain may attempt to be validated using the root of trust (e.g., a public key). Thus, the first certificate in the chain may only be validated if the private key (e.g., controlled by the manufacturer) corresponding to the root of trust was used to sign certificate 178. Other certificates in the chain may be similarly validated by using the public key from the delegation statement of the previous certificate to check the signature in the next certificate in the chain. Certificate chain 182 may include any number of certificates (e.g., 178 through 180) that can be sequentially verified back to the root of trust. Refer to FIGS. 1G-1H for additional information regarding establishing valid certificate chains.

Turning to FIG. 1G, a diagram of an example process for validating a portion of a certificate chain of an ownership voucher in accordance with an embodiment is shown. In FIG. 1G, two certificates (e.g., 184, 188) from a certificate chain are shown.

As seen, certificate 184 may include delegation 185 which includes a public key (e.g., 186) of a second entity. The delegation statement may indicate that a first entity is delegating authority to the second entity.

Certificate 184 may include signature 187. Signature 187 may be generated using a private key controlled by the first entity that delegated authority to the second entity. In this example, the private key may correspond to root of trust 160 (e.g., may be a private corresponding to the public key installed when an endpoint device is manufactured).

To establish a certificate chain, signature 187 may be checked using root of trust 160. If verified as having been signed using the private key corresponding to the root of trust, then certificate 184 may be treated as being valid.

Like certificate 184, certificate 188 may include delegation 189 which includes a public key (e.g., 190) of a third entity, and in this example the owner. The delegation statement of delegation 189 may indicate that the second entity is delegating authority to the third entity (i.e., the owner).

Certificate 188 may include signature 191. Signature 91 may be generated using a private key controlled by the second entity that delegated authority to the third entity. In this example, the private key may correspond to the public key (e.g., 186) of the second entity which may be included in delegation 185.

To extend the certificate chain, signature 191 may be checked using public key of second entity 186. If verified as having been signed using the private key corresponding to public key of second entity 186, then certificate 188 may be treated as being valid.

Once the chain is established, the delegations (e.g., 185, 189) in the chain may be parsed to identify keys to which authority has been delegated from root of trust 160. These public key may then be used to decide whether various work orders are valid, which entities have authority of an endpoint device, and/or for other purposes.

For example, during onboarding, an endpoint device may evaluate whether to perform various work orders using the keys to which authority has been delegated.

Turning to FIG. 1H, a diagram of an example process for validating a work order in accordance with an embodiment is shown. In FIG. 1H, only a portion of the certificates (e.g., 184, 188) shown in FIG. 1G are shown for clarity.

When a work order (e.g., 196) is received by an endpoint device, the endpoint device may evaluate whether the entity issuing the work order has authority over the endpoint device. To do so, the endpoint device may parse the certificates to identify the public keys to which authority over the endpoint device has been delegated.

The endpoint device may then, using the keys, check a signature (e.g., 198) included in the work order. If the signature can be verified as having been generated using the private key corresponding to one of the public keys to which authority over the endpoint device has been delegated, then the endpoint device may treat work order 196 as having been issued by an entity with authority over it. For example, signature 198 may be checked using public key of owner entity 190, in this example.

The endpoint device may then, for example, process various statements 197 included in work order 196, and take action based on those statements. These statements may include instructions that change the manner of operation of the endpoint device to, for example, comply with security requirements of a new owner, and/or perform other actions.

For example, turning to FIG. 1I which shows a diagram in accordance with an embodiment, signed data 204 such as a work order may be validated if public keys included in ownership voucher certificate chains (e.g., 202) correspond to private keys to which the work order issuing entity has access. In this example, ownership voucher certificate chain 202 may be used to establish delegations of authority from root of trust 200 for an endpoint device to the keys used to sign signed data 204.

Turning now to FIG. 1J, FIG. 1J shows an example of orchestrator 132 discussed above in FIG. 1A. As shown in FIG. 1J, the orchestrator comprises an orchestrator onboarding client 210, BMO data 212, and application data 214.

In embodiments, the endpoint device onboarding client 216 may be implemented in hardware, software, or a combination of both. The endpoint device onboarding client 216 may be used to communicate with a rendezvous system (e.g., rendezvous system 120) to establish with the rendezvous system that the orchestrator has authority over one or more endpoint devices (e.g., any of the endpoint devices 102 and 134 of FIG. 1A). The endpoint device onboarding client 216 may also compile and transmit any number of payloads (e.g., payloads containing the BMO data 212, the application data 214, or the like) to the rendezvous system.

In embodiments, the endpoint device onboarding client 216 may also implement any and all necessary processes to connect to, validate, and orchestrate onboarding with any number of endpoint devices (e.g., in particular, with any of the clients discussed below in reference to FIG. 1K) to onboard the endpoint devices onto a control plane on which the orchestrator 132 is sitting.

By storing both BMO data and application data, the orchestrator 132 can advantageously act (e.g., serve) as both a BMO control plane and an application control plane of an endpoint device (e.g., any of the endpoint devices 134 of FIG. 1A).

FIG. 1K shows an example of an endpoint device (e.g., endpoint device 136 of FIG. 1A). As shown in FIG. 1K, endpoint device 136 includes an endpoint device onboarding client 216, a BMO client 217, and an application onboarding client 218. Each of these clients may communicate with the endpoint device onboarding client 216 of the example orchestrator 132 in FIG. 1J to completing the onboarding of the endpoint device to a control plane in cooperation with the orchestrator.

In embodiments, endpoint device onboarding client 216 may be in charge of communicating with the orchestrator (and the rendezvous system), the BMO client 217 may be solely in charge of completing BMO on the endpoint device (e.g., using obtained BMO data 212), and the application onboarding client 218 may be solely in charge of completing application configurations and settings (or any other applicable or similar process) (e.g., using obtained application data 214 from, for example, the orchestrator) after completion of the BMO once the endpoint device is onboarded (using endpoint device onboarding client 216) onto an intended application control plane of the endpoint device 136.

Having separate clients for BMO and application onboarding advantageously allows each client to ignore data that is not applicable to processes being executed by that client (e.g., BMO client 217 may ignore all data that is not BMO data 212, and vice versa). Each client would also be configured for specific tasks (e.g., BMO installation, application-specific instructions, or the like), allowing more simplistic designs and implementation that could use up less of the limited computing resources of the endpoint devices when these tasks are being implemented.

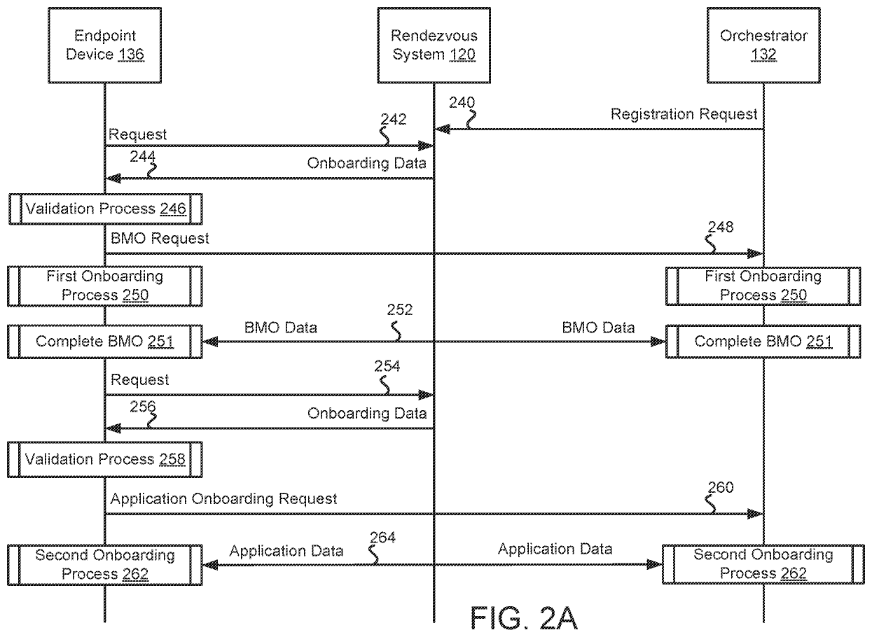

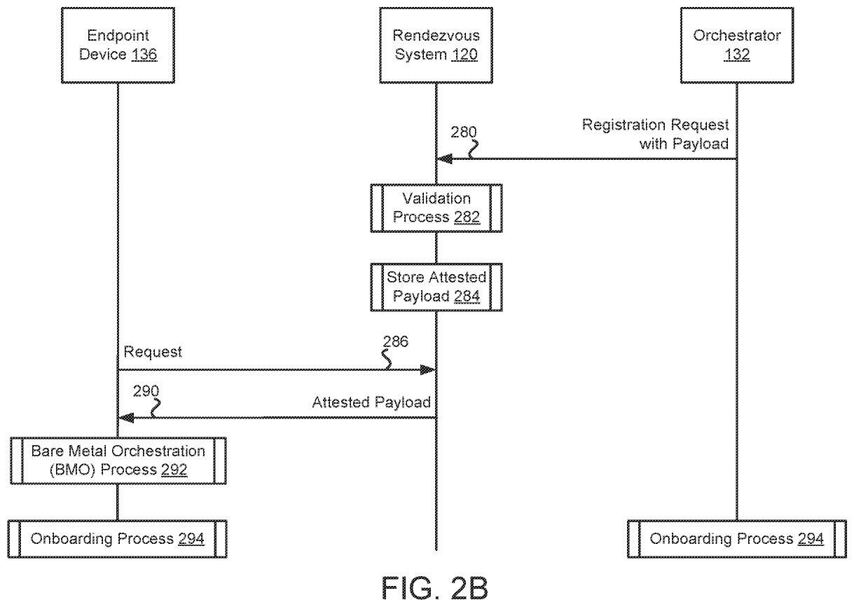

To further clarify embodiments disclosed herein, interactions diagrams in accordance with an embodiment are shown in FIGS. 2A-2C. These interactions diagrams may illustrate how data may be obtained and used within the system of FIGS. 1A-1K.

In the interaction diagrams, processes performed by and interactions between components of a system in accordance with an embodiment are shown. In the diagrams, components of the system are illustrated using a first set of shapes (e.g., 132, 120, 136, etc.), located towards the top of each figure. Solid lines descend from this first set of shapes to indicate that the devices are operating during the corresponding period of time.

Processes performed by the components of the system are illustrated using a second set of shapes (e.g., 246, 250, 251, 258, etc.) superimposed over these lines. Interactions (e.g., communication, data transmissions, etc.) between the components of the system are illustrated using a third set of shapes (e.g., 240, 242, 244, 254, 256, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 240 may occur prior to the interaction labeled as 244. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during onboarding of an endpoint device.

To onboard endpoint device 136, orchestrator 132 may, at interaction 240, orchestrator 132 may send a registration request to rendezvous system 120. The registration request may be a request to have rendezvous system 120 redirect endpoint device 136 to orchestrator 132. The registration request may include information (such as the ownership voucher of the endpoint device) usable by rendezvous system 120 to verify that orchestrator 132 should have authority over endpoint device 136.

Once endpoint device 136 reaches a destination location (e.g., a data center, edge deployment, etc.), endpoint device 136 may be powered on and may, at interaction 242, send a request to rendezvous system 120 regarding which entity to contact as part of an onboarding procedure (namely, to a BMO control plane of the endpoint device 136).

Presuming the rendezvous system 120 registered orchestrator 132 based on the registration request (at interaction 240), rendezvous system may, at interaction 244, provide onboarding data to endpoint device 136. The onboarding data may include, for example, various validation information and re-direct information (e.g., network address) for orchestrator 132.

Once obtained, endpoint device 136 may perform validation process 246. During validation process 246, endpoint device 136 may attempt to validate the onboarding data (e.g., using the ownership voucher, or the like). If successfully validated, endpoint device 136 may, at interaction 248, generate and send a BMO onboarding request (also referred to herein as “BMO request”) to orchestrator 132. The BMO onboarding request may request, for example, cryptographic data such as ownership vouchers and onboarding to complete a BMO of the endpoint device 136 (e.g., using BMO data 212 of FIG. 1J). The request may initiate a cooperatively performed first onboarding process 250 by endpoint device 136 and orchestrator 132 to complete BMO of the endpoint device using exchange of BMO data (at process 251 and at interaction 252) between the endpoint device 136 and orchestrator 132.

During first onboarding process 250, orchestrator 132 may provide endpoint device 136 with the ownership voucher and/or other information to enable endpoint device 136 to ascertain whether orchestrator 132 has authority over endpoint device 136. To do so, endpoint device 136 may, as discussed above, attempt to validate certificate chains and delegation statements to establish a chain of delegation of authority from the root of trust to orchestrator 132 (e.g., the delegation statements may identify a particular public key for which orchestrator 132 controls a corresponding private key). Endpoint device 136 may issue various challenges (e.g., signing challenges) to orchestrator 132, and endpoint device 136 may test the signed responses to the challenges using the particular public key. If the signed responses can be validated using the public key, then endpoint device 136 may conclude that orchestrator 132 has authority over it.

If successfully validated as having authority over it, endpoint device 136 may continue to participate in the first onboarding by, for example, evaluating the trustworthiness of signed work orders issued by orchestrator 132, and complying with any signed work orders that can be validated as having been signed with the private key corresponding to the particular public key. These signed work orders may include the BMO data (e.g., BMO data 212 of FIG. 1J), and may be transferred to the endpoint device 136 at interaction 252.

The aforementioned work orders may cause endpoint device 136 to, for example, to complete a BMO of the endpoint device (e.g., modify its configuration, install/remove software, enable/disable various hardware components, and/or perform other operations as directed by orchestrator 132). The aforementioned operations may place endpoint device 136 in a completed BMO state.

In this completed BMO state, an operating system of the endpoint device 136 may be installed and booted up. At this stage, although applications and software are installed on the endpoint device 136, specific configurations (e.g., user accounts, settings, or the like) of these applications and software are not yet configured. These application-specific credentialling processes will require onboarding of the endpoint device onto an application control plane intended for the endpoint device.

Once BMO is completed at 251, if the endpoint device only required BMO (with no subsequent onboarding to an application control plane) the process shown in the diagram of FIG. 2A may end upon completion of process and interaction 251 and 252.

Alternatively, if subsequent onboarding to the application control plane is required, the process proceeds to interaction 254 where (similar to interaction 242) the endpoint device may send another request to rendezvous system 120 regarding which entity to contact as part of a subsequent onboarding procedure (namely, for onboarding onto an application control plane of the endpoint device 136).

Presuming the rendezvous system 120 registered orchestrator 132 (as the endpoint device's application control plane) based on the registration request (at interaction 240), rendezvous system may, at interaction 256 (similar to interaction 244), provide onboarding data to endpoint device 136. The onboarding data may include, for example, various validation information and re-direct information (e.g., network address) for orchestrator 132.

Once obtained, endpoint device 136 may again perform validation process 258 (similar or identical to validation process 246). During validation process 258, endpoint device 136 may attempt to validate the onboarding data. If successfully validated, endpoint device 136 may, at interaction 260, generate and send an application onboarding request to orchestrator 132. The application onboarding request may request, for example, cryptographic data such as ownership vouchers. The request may initiate a cooperatively performed second onboarding process 262 (namely, an application onboarding) by endpoint device 136 and orchestrator 132.

During the second onboarding process 262, similar or identical to process 250, orchestrator 132 may provide endpoint device 136 with the ownership voucher and/or other information to enable endpoint device 136 to ascertain whether orchestrator 132 has authority over endpoint device 136. To do so, endpoint device 136 may, as discussed above, attempt to validate certificate chains and delegation statements to establish a chain of delegation of authority from the root of trust to orchestrator 132 (e.g., the delegation statements may identify a particular public key for which orchestrator 132 controls a corresponding private key). Endpoint device 136 may issue various challenges (e.g., signing challenges) to orchestrator 132, and endpoint device 136 may test the signed responses to the challenges using the particular public key. If the signed responses can be validated using the public key, then endpoint device 136 may conclude that orchestrator 132 has authority over it.

If successfully validated as having authority over it, endpoint device 136 may continue to participate in the onboarding by, for example, evaluating the trustworthiness of signed work orders issued by orchestrator 132, and complying with any signed work orders that can be validated as having been signed with the private key corresponding to the particular public key. These signed work orders (received as part of interaction 264) may include application data (e.g., application data 214 (also referred to herein as “application onboarding data”)) containing specific application-specific credentialling information (e.g., user ID and password for one or more applications, specific settings and/or add-ons for one or more applications, or the like).

The aforementioned work orders may cause endpoint device 136 to, for example, modify all of the applications and/or other similar software installed as part of the BMO for the endpoint device. The aforementioned operations may place these installed applications and/or other similar software of the endpoint device 136 in an operating state specified by the owner of endpoint device 136.

For example, assume that at process 250-252 a specific application such as Microsoft® WORD was installed. During the second onboarding process 262, the endpoint device 136 uses the application data to specifically configure the installed copy of Microsoft® WORD to an intended operating state specified by the owner (e.g., a business or corporation) of endpoint device 136. For example, specific plug-ins, add-ons for the application may be installed. The application may also be provided with credential information (e.g., an activation/registration key, sign-in information of a specific employee, or the like) to activate the application.

Turning now to FIG. 2B, a second interaction diagram in accordance with an embodiment is shown. The first interaction diagram may illustrate processes and interactions that may occur during onboarding of an endpoint device.

To onboard endpoint device 136, orchestrator 132 may, at interaction 280, orchestrator 132 may send a registration request to rendezvous system 120. The registration request may be a request to have rendezvous system 120 directly provide an attested payload (e.g., a payload attested by the rendezvous system as belonging to the orchestrator) to the endpoint device 136. The registration request may include information (such as the ownership voucher of the endpoint device) usable by rendezvous system 120 to verify that orchestrator 132 should have authority over endpoint device 136. The registration request may also include a payload. The payload may be configured to store any type and any amount of data including, but limited to, any (or any combination of): (i) BMO data 212; (ii) application data 214; (iii) an ownership voucher; (iv) any number of signed work orders associated with data of (i)-(iii); or the like.

Once obtained, rendezvous system may perform validation process 282 to validate the payload and to register orchestrator 132 with endpoint device 136. During validation process 282, rendezvous system 120 may attempt to validate the payload received from the orchestrator 132 (e.g., using the ownership voucher, or the like). The validation process 282 may involve the cryptographical validation process described above in reference to FIGS. 1G-1I.

If successfully validated, the rendezvous system 120 may associate orchestrator 132 with endpoint device 136 and store the payload received from the orchestrator 132 (now an attested payload that has been attested by the rendezvous system 120) within one or more storage devices of the rendezvous system (e.g., in operation/process 284).

At some point after the attested payload has been stored by the rendezvous system 120, endpoint device 136 may reach a destination location (e.g., a data center, edge deployment, etc.). At this time endpoint device 136 may be powered on and may, at interaction 286 (similar or identical to interactions 242 and 254 of FIG. 2A), send a request to rendezvous system 120 regarding which entity to contact as part of an onboarding procedure. (including both BMO and application onboarding).

Presuming the rendezvous system 120 registered orchestrator 132 based on the registration request (at interaction 280) and stored the attested payload (at process 284), rendezvous system may, at interaction 290, (instead of redirecting the endpoint device 136 to orchestrator 132) provide the stored attested payload to endpoint device 136.

Assume for this example in FIG. 2B that the attested payload only includes data (e.g., BMO data 212, signed work orders, or the like) associated with a BMO of the endpoint device 136 (that the attested payload only includes BMO instructions). Once the endpoint device 136 obtains the attested payload, the endpoint device 136 may initiate a BMO process 292 to use the data (e.g., the BMO instructions) included in the attested payload to complete a BMO (without having to first onboard itself onto the orchestrator 132 (namely, a BMO control plane constituting the orchestrator 132)).

In embodiments, such BMO instructions (namely the signed work orders making up the BMO instructions) may be signed using a secret key associated with a current owner of the endpoint device. Before using the BMO instructions to complete the BMO of the endpoint device, the endpoint device may (e.g., cryptographically using the process discussed above in reference to FIGS. 1G-1I) validate an integrity of the BMO instructions using an ownership voucher of the endpoint device to determine that the BMO instructions can be trusted.

Once BMO is completed at 292, if the endpoint device only required BMO (with no subsequent onboarding to an application control plane) the process shown in the diagram of FIG. 2B may end upon completion of process 292. Said another way, the BMO of the endpoint device 136 can be completed without ever having to connect the endpoint device 136 with the orchestrator.

Alternatively, if subsequent onboarding to the application control plane is required, the process proceeds to process 294 where the endpoint device 136 may initiate and complete the application onboarding (by executing processes and interactions similar or identical to processes and interactions 254-264 discussed in FIG. 2A).

In embodiments, although FIG. 2B was described as only including BMO related data in the attested payload, any type of data may be included in the attested payload without departing from the scope of embodiments disclosed herein. For example, the application data 214 of FIG. 1J may also be included in the attested payload such that the entire initial configuration of the endpoint device 136 can be completed without ever having to actually onboard the endpoint device 136 onto any control planes (e.g., a BMO control plane, an application control plane, or the like).

Any of the processes illustrated in FIGS. 2A-2B using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated in FIGS. 2A-2B using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions illustrated in FIGS. 2A-2B may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

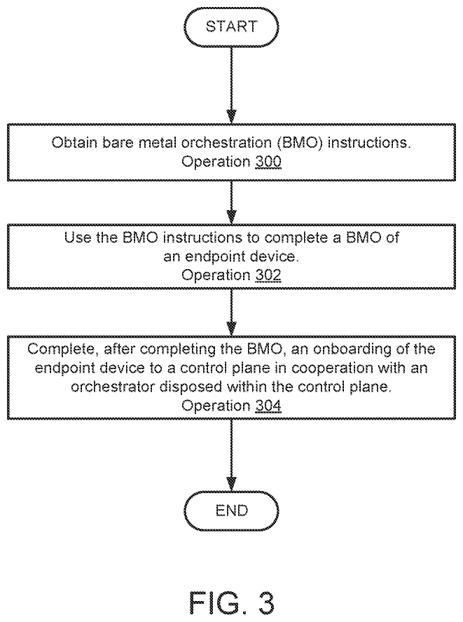

As discussed above, the components of FIG. 1A may perform various methods to onboarding endpoint devices. FIG. 3 illustrates a method that may be performed by the components of the system of FIGS. 1A-1K. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for performing an onboarding in accordance with an embodiment is shown. The method may be performed by any of the components of the system shown in FIG. 1A.

In operation 300, an endpoint device may obtain BMO instructions. As discussed above in reference to FIGS. 2A and 2B, the endpoint device may obtain the BMO instructions: (i) directly from an orchestrator after being onboarded to that orchestrator; or (ii) or directly from a rendezvous system that received the BMO instructions (in the form of an attested payload) from the orchestrator).

In operation 302, as discussed above in reference to FIGS. 2A-2B, the endpoint device may use the BMO instructions to complete a BMO of the endpoint device. Once BMO is completed, if the endpoint device only required BMO (with no subsequent onboarding to an application control plane) the process may end at operation 302. Alternatively, if subsequent onboarding to the application control plane is required, the process proceeds to operation 304.

In operation 304, as discussed above in reference to FIGS. 2A-2B, the endpoint device may, after completing the BMO, complete an onboarding (namely, an application onboarding) of the endpoint device to a control plane (namely, an application control plane) in cooperation with an orchestrator disposed within the control plane. This is discussed above in references to interactions and processes 254-264 of FIG. 2A and process 294 of FIG. 2B.

The process may end following operation 304.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing an endpoint device of endpoint devices in a deployment, the method comprising:
during an onboarding of the endpoint device and by the endpoint device:
obtaining bare metal orchestration (BMO) instructions;
using the BMO instructions to complete a BMO of the endpoint device; and
after completing the BMO of the endpoint device, completing the onboarding of the endpoint device to a control plane in cooperation with an orchestrator, the orchestrator being located within the control plane to which the endpoint device is to connect and receive onboarding data for completing the onboarding.

2. The method of claim 1, wherein the BMO instructions are obtained from a rendezvous system that is disposed external to the control plane from which the endpoint device is to be provided with the onboarding data.

3. The method of claim 2, further comprising:
before obtaining the BMO instructions from the rendezvous system:
transmitting a request to the rendezvous system, the request being for obtaining information regarding an entity to contact for obtaining the BMO instructions, the entity being the orchestrator; and
receiving, in response to the request and directly from the rendezvous system without the endpoint device having to first contact the entity, the BMO instructions in addition to the information as part of the BMO instructions.

4. The method of claim 3, wherein the BMO instructions are signed using a secret key associated with a current owner of the endpoint device.

5. The method of claim 4, wherein the BMO instructions are provided to the rendezvous system by the orchestrator prior to the endpoint device transmitting a request to the rendezvous system to initiate an onboarding process, and the rendezvous system validates an integrity of the BMO instructions by validating that the orchestrator is associated with the current owner of the endpoint device.

6. The method of claim 4, further comprising:
before using the BMO instructions to complete the BMO of the endpoint device:
validating an integrity of the BMO instructions using an ownership voucher of the endpoint device; and
determining that the BMO instructions are trusted using the ownership voucher.

7. The method of claim 6, wherein
the ownership voucher comprises another key associated with the current owner of the endpoint device, the another key being a public key of a public private key pair, and the secret key being a private key of the public private key pair, and
determining that the BMO instructions are trusted comprises determining that the another key is referenced by the secret key used to sign the BMO instructions.

8. The method of claim 2, wherein the orchestrator is both a BMO control plane and an application control plane of the endpoint device.

9. The method of claim 8, wherein the endpoint device comprises a BMO client and an application onboarding client that is different from the BMO client, the BMO client being used to complete the BMO of the endpoint device.

10. The method of claim 9, wherein completing the onboarding of the endpoint device with the orchestrator after completing the BMO of the endpoint device comprises:
executing, by the application onboarding client, application onboarding data to complete configuration of one or more applications installed on the endpoint device after completing the BMO of the endpoint device.

11. A non-transitory machine-readable medium having instructions stored therein, which when executed by a processor of an endpoint device of endpoint devices in a deployment, cause the processor to perform operations for managing the endpoint device, the operations comprising:
during an onboarding of the endpoint device:
obtaining bare metal orchestration (BMO) instructions;
using the BMO instructions to complete a BMO of the endpoint device; and
after completing the BMO of the endpoint device, completing the onboarding of the endpoint device to a control plane in cooperation with an orchestrator, the orchestrator being located within the control plane to which the endpoint device is to connect and receive onboarding data for completing the onboarding.

12. The non-transitory machine-readable medium of claim 11, wherein the BMO instructions are obtained from a rendezvous system that is disposed external to the control plane from which the endpoint device is to be provided with the onboarding data.

13. The non-transitory machine-readable medium of claim 12, wherein the operations further comprise:
before obtaining the BMO instructions from the rendezvous system:
transmitting a request to the rendezvous system, the request being for obtaining information regarding an entity to contact for obtaining the BMO instructions, the entity being the orchestrator; and
receiving, in response to the request and directly from the rendezvous system without the endpoint device having to first contact the entity, the BMO instructions in addition to the information as part of the BMO instructions.

14. The non-transitory machine-readable medium of claim 13, wherein the BMO instructions are signed using a secret key associated with a current owner of the endpoint device.

15. The non-transitory machine-readable medium of claim 14, wherein the BMO instructions are provided to the rendezvous system by the orchestrator prior to the endpoint device transmitting a request to the rendezvous system to initiate an onboarding process, and the rendezvous system validates an integrity of the BMO instructions by validating that the orchestrator is associated with the current owner of the endpoint device.

16. An endpoint device, comprising:
a processor; and
a memory coupled to the processor to store instructions, which when executed by the processor, cause the endpoint device to perform operations for onboarding, the operations comprising:
during an onboarding of the endpoint device:
obtaining bare metal orchestration (BMO) instructions;
using the BMO instructions to complete a BMO of the endpoint device; and
after completing the BMO of the endpoint device, completing the onboarding of the endpoint device to a control plane in cooperation with an orchestrator, the orchestrator being located within the control plane to which the endpoint device is to connect and receive onboarding data for completing the onboarding.

17. The endpoint device of claim 16, wherein the BMO instructions are obtained from a rendezvous system that is disposed external to the control plane from which the endpoint device is to be provided with the onboarding data.

18. The endpoint device of claim 17, wherein the operations further comprise:
before obtaining the BMO instructions from the rendezvous system:
transmitting a request to the rendezvous system, the request being for obtaining information regarding an entity to contact for obtaining the BMO instructions, the entity being the orchestrator; and
receiving, in response to the request and directly from the rendezvous system without the endpoint device having to first contact the entity, the BMO instructions in addition to the information as part of the BMO instructions.

19. The endpoint device of claim 18, wherein the BMO instructions are signed using a secret key associated with a current owner of the endpoint device.

20. The endpoint device of claim 19, wherein the BMO instructions are provided to the rendezvous system by the orchestrator prior to the endpoint device transmitting a request to the rendezvous system to initiate an onboarding process, and the rendezvous system validates an integrity of the BMO instructions by validating that the orchestrator is associated with the current owner of the endpoint device.
